(19) United States
(12) Patent Application Publication
(10) Pub. No.: US 2003/0030876 A1
(43) Pub. Date: Feb. 13, 2003

(54) Optical transmitter, optical receiver and light wavelength multiplexing system

(76) Inventor: Yuko Takei, Tokyo (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/212,036

(22) Filed: Aug. 6, 2002

(30) Foreign Application Priority Data
Aug. 13, 2001 (JP) 2001-245708

(51) Int. Cl. H04J 14/02; H04B 10/00; H04B 10/04

(52) U.S. Cl. 359/187; 359/180; 359/124

(57) ABSTRACT

In an optical transmitter, an optical receiver and an optical wavelength multiplexing system, they can reduce the number of expensive optical parts, and can also protect a mutual interference with multiplexed optical signals of other channels, even if a wavelength interval of a signal light source is extremely narrow. Output lights of a plurality of signal laser modules and a stabilzed light source having a wavelength stableness higher than them are coupled with one wave of an adjacent wavelength. A photo-electric conversion and a heterodyne detection are performed thereon to thereby obtain a beat signal. Then, a wavelength of a signal laser module is controlled such that a frequency of the beat signal is constant. If a wavelength stabilzed light source is not used, only a relative wavelength stabilization through the heterodyne detection is carried out, and a fluctuation in an absolute wavelength is detected in a wavelength routing unit. Consequently, it is compensated.

### BACKGROUND OF THE INVENTION

1. Field of the Invention

The present invention relates to an optical transmitter, an optical receiver and an optical wavelength multiplexing system for stabilizing and controlling a plurality of different laser wavelengths and multiplexing and transmitting them. z 1

2. Description of the Related Art

In recent years, the rapid spread of the Internet leads to the explosive increase of data traffics in a main communication network. This explosive increase requires a large capacity communication system in which a larger number of information can be transmitted at a high speed. In the above-mentioned circumstance, an optical wavelength multiplexing system, such as WDM (Wavelength Division Multiplexing), DWDM (Dense Wavelength Division Multiplexing) and the like, which transmits a plurality of different optical signals through one optical fiber, can sharply increase an information transmission amount by using an existing system in its original state without newly laying the optical fiber. Thus, it is considered as the strongest method to make the capacity of the communication network larger.

In this system, a fluctuation of a certain optical signal causes a mutual interference with a multiplexed optical signal of a different channel. Thus, the wavelength of a signal light must be kept extremely stable. A technique noted in Japanese Laid Open Patent Application (JP-A-Heisei, 7-202311) is listed as a technique for attaining it.

FIG. 7 is a block diagram showing a wavelength stabilizing method of an apparatus of a semiconductor laser noted in the above-mentioned gazette. A semiconductor laser module 201 includes: a semiconductor laser 202 for converting an input electric signal into an optical signal; a monitoring potodiode 203 for monitoring a backward emitting light of the semiconductor laser 202; and a Peltier cooling element 204 serving as a cooling element placed near the semiconductor laser 202. A forward emitting light of the semiconductor laser 202 is sent through a lens (not shown) to an optical fiber. A control circuit 205 is connected to the semiconductor laser module 201. An injection current to the semiconductor laser 202 is controlled so as to keep a monitoring current of the monitoring potodiode 203 constant.

The optical signal emitted from the semiconductor laser module 201 is inputted to an optical fiber amplifier 206, and amplified thereby, and then sent out to a transmission path. An amplified light sent out by the optical fiber amplifier 206 is branched by a first optical branch 208, and this branched light is further branched by a second optical branch 209. One of the lights branched by this second optical branch 209 is converted into an electric signal by a first light receiving module 210. As for the other light, a wavelength component of a part thereof is selected by a wavelength filter 211 for passing only the light having a wavelength slightly different from a peak wavelength of the amplified light, and it is converted into an electric signal by a second light receiving module 212. The electric signals obtained by the first light receiving module 210 and the second light receiving module 212 are inputted to a temperature control circuit 213, and an electric power ratio is calculated. The temperature control circuit 213 controls a value of a current to the cooling element 204 so that the electric power ratio becomes contact.

In this configuration, if an atmosphere temperature of the semiconductor laser module 201 is increased and the wavelength is shifted to the side of the longer wavelength, the wavelength of the amplified light is also shifted to the side of the longer wavelength. Thus, a rate of a transmitted light intensity of the wavelength filter 211 to an intensity of the entire amplified light is increased. At this time, the monitoring potodiode 203 decreases a temperature of the cooling element 204. On the contrary, if the atmosphere temperature of the semiconductor laser module 201 is decreased, the wavelength of the amplified light is shifted to the shorter wavelength. Thus, the rate of the transmitted light intensity of the wavelength filter 211 to the intensity of the entire amplified light is decreased. At this time, it increases the temperature of the cooling element 204.

However, the above-mentioned conventional wavelength control method requires the optical parts for adjusting the wavelength, such as the wavelength filter 211 and the optical fiber amplifier 206, which are very high in accuracy and stableness, and the like, for each of several tens of signal light sources. Thus, this method brings about a problem of an increase in a cost of the entire system. Also, if the further advance in the optical multiplexing causes a wavelength interval between the signal lights to be narrower, in the case of the conventional method of stabilizing the wavelengths of the respective signal lights through the controls independent of each other, it is difficult to keep the wavelengths of the respective signal lights at the wavelength interval which does not involve the interference with other signal lights.

In view of the above-mentioned problems, it is therefore an object of the present invention to provide an optical transmitter, an optical receiver, and an optical wavelength multiplexing system, which can reduce the number of expensive optical parts, and can also protect a mutual interference with multiplexed optical signals of other channels, even if a wavelength interval of a signal light source is extremely narrow.

### SUMMARY OF THE INVENTION

In order to attain the above-mentioned objects, the optical transmitter of the present invention includes:

a plurality of signal light sources for respectively emitting lights each having different wavelength from one another;

a unit for obtaining a beat signal by coupling an emitting light from the signal light source with one wave of an adjacent wavelength and carrying out a photo-electric conversion; and

a unit for controlling the wavelength of the signal light source so that a frequency of the beat signal is constant.

Also, in order to attain the above-mentioned objects, the optical transmitter of the present invention comprises:

a plurality of signal light sources for respectively emitting lights each having different wavelength from one another;

a reference light source;

a unit for obtaining a beat signal by coupling emitting lights from the reference light source and the signal light source with one wave of an adjacent wavelength and carrying out a photo-electric conversion; and

a unit for controlling the wavelength of the signal light source so that a frequency of the beat signal is constant.

In order to attain the above-mentioned objects, an optical receiver of the present invention comprises:

a unit for branching a light into three directions and sending to an optical branching filter and a first wavelength filter and a second wavelength filter which are different in transmission property;

a unit for detecting transmitted light intensities of the first wavelength filter and the second wavelength filter; and

a unit for calculating a ratio between the transmitted light intensity of the first wavelength filter and the transmitted light intensity of the second wavelength filter, and calculating a deviation amount of this ratio from a predetermined standard value, and then shifting peaks of all transmission wavelengths of the optical branching filter by an equal amount, in accordance with the deviation amount.

Also, in order to attain the above-mentioned objects, an optical receiver of the present invention comprises:

a unit for branching a light into two directions, and sending to a variable wavelength filter and an optical branching filter, respectively;

a unit for detecting a transmitted light intensity of the variable wavelength filter;

a unit for sweeping a transmission wavelength of the variable wavelength filter with a predetermined wavelength as an origin, and after the transmitted light intensity of the variable wavelength filter passes a first peak, detecting a transmission wavelength when it becomes firstly smaller by a certain rate than the peak; and

a unit for shifting the peaks of all of the transmission wavelengths of the optical branching filter by an equal amount in accordance with the detected transmission wavelength.

Due to the above-mentioned configuration, it is possible to send and receive the multiplexed wavelength signal which is extremely stable, only by adjusting a relative wavelength through a heterodyne detection, without any absolute wavelength control using the expensive optical elements such as a wavelength filter, an optical resonator and the like, for each laser for a signal. Thus, it is possible to reduce the number of the expensive optical elements, and also possible to protect a mutual interference with multiplexed optical signals of other channels, even if a wavelength interval of a signal light source is extremely narrow.

Also, the signal light source is a semiconductor laser, and its wavelength is controlled by changing a temperature of the semiconductor laser.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the signal light source is a semiconductor laser, and its wavelength is controlled by changing a bias current of the semiconductor laser.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the signal light source is a semiconductor laser, and its wavelength is controlled by changing a temperature of the semiconductor laser, and its optical intensity is stabilized and controlled by changing a bias current.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the light outputted to the transmission path is a forward emitting light of the semiconductor laser, and the light used to control the wavelength of the signal light source is a backward emitting light of the semiconductor laser.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the light used to control the wavelength of the signal light source is a light obtained y branching the forward emitting light of the semiconductor laser.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the wavelength controls for the respective signal light sources are all carried out at different speeds.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the first wavelength filter and the second wavelength filter have characteristics so as to transmit a light having the longest wavelength among emitting lights of the signal light source, and transmission wavelength peaks of the first wavelength filter and the second wavelength filter are set on a longer wavelength side than a wavelength fluctuation range of the light having the longest wavelength among the emitting lights of the signal light source.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the first wavelength filter and the second wavelength filter have characteristics so as to transmit a light having the shortest wavelength among the emitting lights of the signal light source, and the transmission wavelength peaks of the first wavelength filter and the second wavelength filter are set on a shorter wavelength side than the wavelength fluctuation range of the light having the shortest wavelength among the emitting lights of the signal light source.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the wavelength of the reference light source is longer than the wavelength of any of the signal lasers, and the origin from which the transmission wavelength of the variable wavelength filter is swept is located on a longer wavelength side than a wavelength fluctuation range of the reference light source, and the sweeping direction is a direction to a shorter wavelength side from a longer wavelength side.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

Also, the wavelength of the reference light source is shorter than the wavelength of any of the signal lasers, and the origin from which the transmission wavelength of the variable wavelength filter is swept is located on a shorter wavelength side than the wavelength fluctuation range of the reference light source, and the sweeping direction is a direction to a longer wavelength side from a shorter wavelength side.

Due to the above-mentioned configuration, it is possible to reduce the number of the expensive optical elements, and also possible to protect the mutual interference with the multiplexed optical signals of the other channels, even if the wavelength interval of the signal light source is extremely narrow.

On of the above-mentioned transmitters and one of the above-mentioned receiver may be combined to provide an optical wavelength multiplexing system.

### BRIEF DESCRIPTION OF THE DRAWINGS

These and other objects and features will become more readily apparent from the following detailed description taken in conjunction with the accompanying drawings in which:

FIG. 1 is a schematic block diagram showing an optical transmitter, an optical receiver and an optical wavelength multiplexing system in a first embodiment of the present invention;

FIG. 2 is a schematic block diagram showing an optical transmitter, an optical receiver and an optical wavelength multiplexing system in a second embodiment of the present invention;

FIG. 3 is an explanatory view showing wavelength properties of a first wavelength filter and a second wavelength filter of FIG. 2;

FIG. 4 is an explanatory view showing a relation between wavelengths of lights incident to the first wavelength filter and the second wavelength filter and Vₙ/Vₙ₊₁;

FIG. 5 is a schematic block diagram showing an optical transmitter, an optical receiver and an optical wavelength multiplexing system in a third embodiment of the present invention;

FIG. 6 is an explanatory view showing a relation between a transmission wavelength of a variable wavelength filter of FIG. 5 and an optical intensity detected by an (n+1)-th light receiver; and

FIG. 7 is a block diagram showing a hardware configuration for stabilizing a wavelength in a conventional light wavelength multiplexing system.

### DETAILED DESCRIPTION OF THE PREFERRED EMBODIMENT

<First Embodiment>

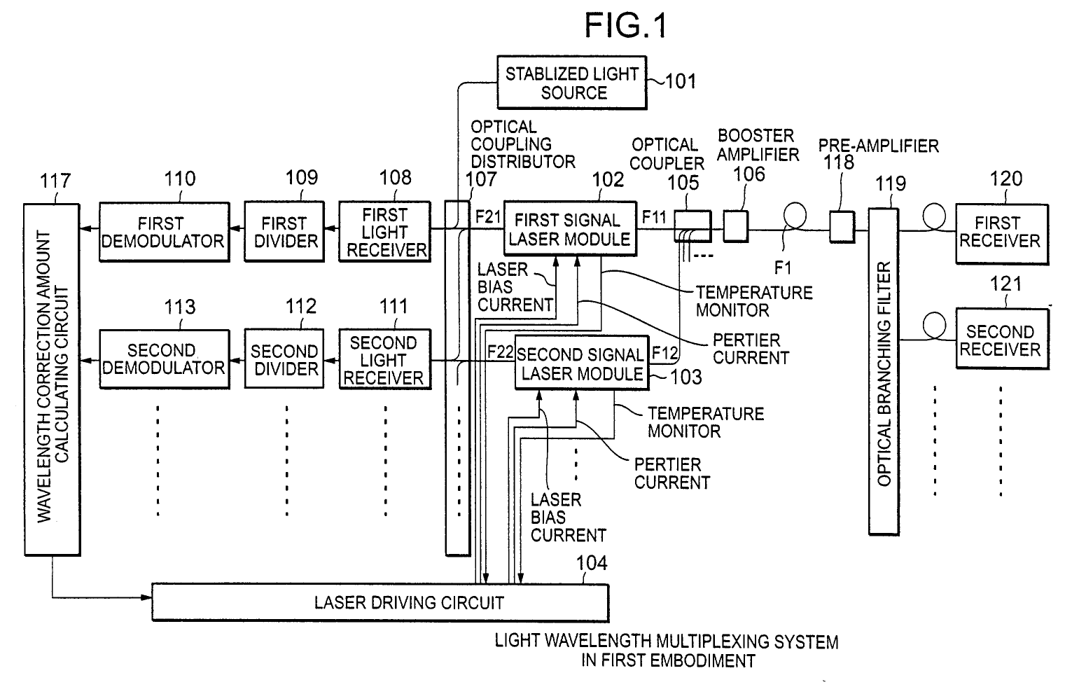

Preferred embodiments of the present invention will be described below with reference to the drawings. FIG. 1 is a schematic block diagram showing an optical transmitter, an optical receiver and an optical wavelength multiplexing system in a first embodiment of the present invention. In FIG. 1, a stabilzed light source 101 is a laser light source, which is controlled such that a fluctuation in a wavelength is extremely smaller than those of first, second, . . . signal laser modules 102, 103, . . . The wavelength of the stabilzed light source 101 is controlled by using, for example, a wavelength filter and an optical resonator, which is high in stableness, and the like and then adjusting a temperature so that the intensities of laser emitting lights transmitted through them are constant.

The first, second, . . . signal laser modules 102, 103, . . . are the semiconductor laser modules in which wavelengths λ₁, λ₂, . . . are set to be slightly different from each other, and a modulation is performed on a bias current. They emit laser lights emitted from front and rear end planes of a laser chip, to the side of optical fibers (F11, F12, . . . ) and the side of optical fibers (F21, F22, . . . ), respectively. The number of the signal laser modules is, for example, 64 in a DWDM system. However, any number may be used.

Forward emitting lights from the respective signal laser modules 102, 103, . . . are coupled by an optical coupler 105, and amplified by a booster amplifier 106, and then inputted through a single transmission path F1 to a pre-amplifier 118. The light amplified by the pre-amplifier 118 is branched into different transmission paths for each wavelengths λ₁, λ₂, . . . by an optical branching filter 119, and received by first, second, . . . receivers 120, 121, . . . . Incidentally, this may be designed such that the emitting from the optical branching filter 119 is not inputted to the first, second receivers 120, 121 and it is inputted to a transponder, and after the wavelength is converted thereby, it is inputted to an existing SDH transmitting apparatus.

Each of backward emitting lights from the respective signal laser modules 102, 103, . . . and an emitting light from the stabilzed light source 101 is coupled with an adjacent wave of a different wavelength by an optically coupling distributor 107, and heterodyne-detected by each of light receivers, such as a first light receiver 108, a second light receiver 111 and the like. The reason why the combination of the coupled lights is done between the lights of the wavelengths adjacent to each other is that a beat frequency obtained by the heterodyne detection is suppressed to a small value, which does not exceed a band of a processing circuit. By the way, the light, in which the beat frequency obtained by the synthesis with the emitting light from the stabilzed light source 101 does not exceed the band of the processing circuit, may be synthesized with the emitting light from the stabilzed light source 101. Also, in the above-mentioned explanation, the light coupled in the optically coupling distributor 107 is used as the backward emitting light of the respective signal laser modules 102, 103, . . . . However, instead of it, the light obtained by branching the forward emitting light may be used. Then, the backward emitting light may be used for a power monitor of the signal laser modules 102, 103, . . . .

The beat signal obtained in the first light receiver 108 is divided by a first divider 109, and inputted to a first demodulator 110. The first demodulator 110 converts a frequency signal into a voltage, and outputs to a wavelength correction amount calculating circuit 117. The process similar to the output of the first light receiver 108 is performed on the beat signals obtained in the second, third, . . . light receivers 111, . . . by using the second, third to nth dividers 112 and the second, third to nth demodulators 113. Incidentally, the demodulators 110, 113, . . . may be any type if the frequency can be detected. For example, a frequency counter may be used instead of them. Also, if the beat frequencies obtained in the light receivers 108, 111, . . . are within the bands of the demodulators 110, 113, . . . , the dividers 109, 112, . . . between the demodulators 110, 113, . . . and the light receivers 108, 111, . . . may be omitted.

The outputs of the respective demodulators 110, 113, . . . are inputted to the wavelength correction amount calculating circuit 117, which calculates a correction amount for a temperature of the signal laser. A method of calculating a correction amount will be described below by exemplifying the first signal laser.

When an optical frequency difference between the stabilzed light source 101 and the first signal laser module 102 is assumed to be ν₁, an input frequency f₁ to the first demodulator 110 is represented by αν₁. Here, α is a constant determined correspondingly to a division number of the divider 109 inserted between the light receiver 108 and the demodulator 110. For example, if the divider 109 is not inserted, α=1. If the division number is 2, α=2. Also, if an output of the first demodulator 110 is V₁, a target value of a frequency interval between the signal laser modules is νₛₜₑₚ, an input frequency of the demodulator 110 when the input frequency of the demodulator 110 becomes ανₛₜₑₚ is f₀, and an output of the demodulator 110 when the input frequency of the demodulator 110 becomes f₀ is V₀, a deviation amount (V₁-V₀) of V₁ from V₀ is represented by β(f-f₀). Here, β is a constant (dV₁/df₁) determined from the property of the demodulator 108. Since f₁, f₀ are represented by αν₁, ανₛₜₑₚ, respectively, the deviation from the ideal value νₛₜₑₚ of the optical frequency difference ν₁ between the first signal laser module 102 and the stabilzed light source 101 is represented by:

(1/α/β)(V₁−V₀)

On the other hand, when the bias current of the first signal laser module 102 is constant, a temperature change amount of the laser required to change ν₁ by Δν₁ is substantially γΔν₁ if a temperature change T₁ is within several ° C. Thus, a temperature correction amount T_{c1} required to make the optical frequency difference ν₁ between the stabilzed light source 101 and the first signal laser module 102 agree with the ideal value νₛₜₑₚ is −γ(ν₁−νₛₜₑₚ). Here, γ is a constant (dT₁/dν₁) determined from the temperature property of the signal laser and the wavelength relation between the first signal laser module 102 and the stabilzed light source 101. If the wavelength of the first signal laser module 102 is longer, γ is a plus value, if the wavelength of the stabilzed light source 101 is longer, γ is a minus value. Since (ν₁−νₛₜₑₚ) is represented by (1/α/β)(V₁−V₀), the temperature correction amount T_{c1} is represented by (−γ/α/β)(V₁−V₀). The wavelength correction amount calculating circuit 117 stores in advance the values of (γ/α/β) and V₀, and calculates T_{c1} from V₁ inputted from the demodulator 110, and then outputs to a laser driving circuit 104. The temperature correction amounts are similarly calculated for the second to nth signal laser modules 103, . . . , and outputted to the laser driving circuit 104.

The laser driving circuit 104 sends the laser bias current to each of the first, second, . . . signal laser modules 102, 103, . . . and controls the temperature. Each of temperature control target values of the signal lasers is the value corrected in accordance with the correction amount calculated by the wavelength correction amount calculating circuit 117. Incidentally, the correction is done from the laser having the wavelength that is the closest to the stabilzed light source 101. When a correction of a next laser is done, the correction amount measured and calculated after the correction of the previous laser is ended is used. Also, if the correction is done by a simple loop control using an analog circuit without any execution of the above-mentioned timing control, a time constant of the circuit is set to be longer as the wavelength is farther from the stabilzed light source.

The above-mentioned method is the method of feeding the fluctuation amount in the output from the frequency detector back to a temperature setting value. However, it is allowable to directly feed back to an amount of a current flowing through a cooling element such as Peltier or the like. Incidentally, if the fluctuation amount in the bias current of the laser is within a range of several tens of milli-amperes, a fluctuation amount in the optical frequency of the laser light is proportional. Thus, the correction may be performed on the bias current instead of the temperature. Also, the optical intensity stabilizing control of the laser may be carried out by using the bias current, and the wavelength control may be carried out by using the temperature. At this time, the backward emitting light of each signal laser may be used as the power monitor.

<Second Embodiment>

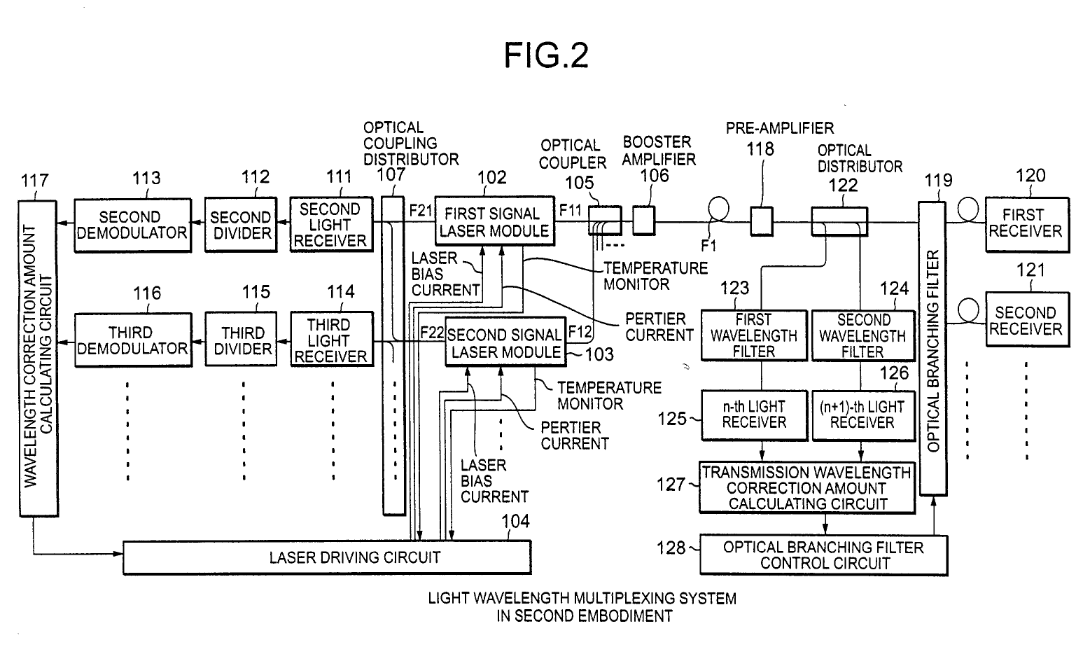

FIG. 2 is a block diagram showing an optical transmitter, an optical receiver and an optical wavelength multiplexing system in a second embodiment. In FIG. 2, (n−1) signal laser modules 102, 103, . . . are the semiconductor laser modules in which wavelengths are set to be slightly different from each other, and the modulation is performed on the bias current. They output the laser lights emitted from the front and rear end planes of the laser chip, to the side of the optical fibers (F11, F12, . . . ) and the side of the optical fibers (F21, F22, . . . ), respectively. Each of the backward emitting lights from the respective signal laser modules is coupled with one wave of the wavelength of the adjacent light by the optically coupling distributor 107, and heterodyne-detected by each of the light receivers 111, 114, . . . . The beat signal obtained by the heterodyne detection is processed by the method similar to the first embodiment. On the basis of the thus-obtained correction amount, the target value of the temperature control or the target value of the laser bias current control is corrected.

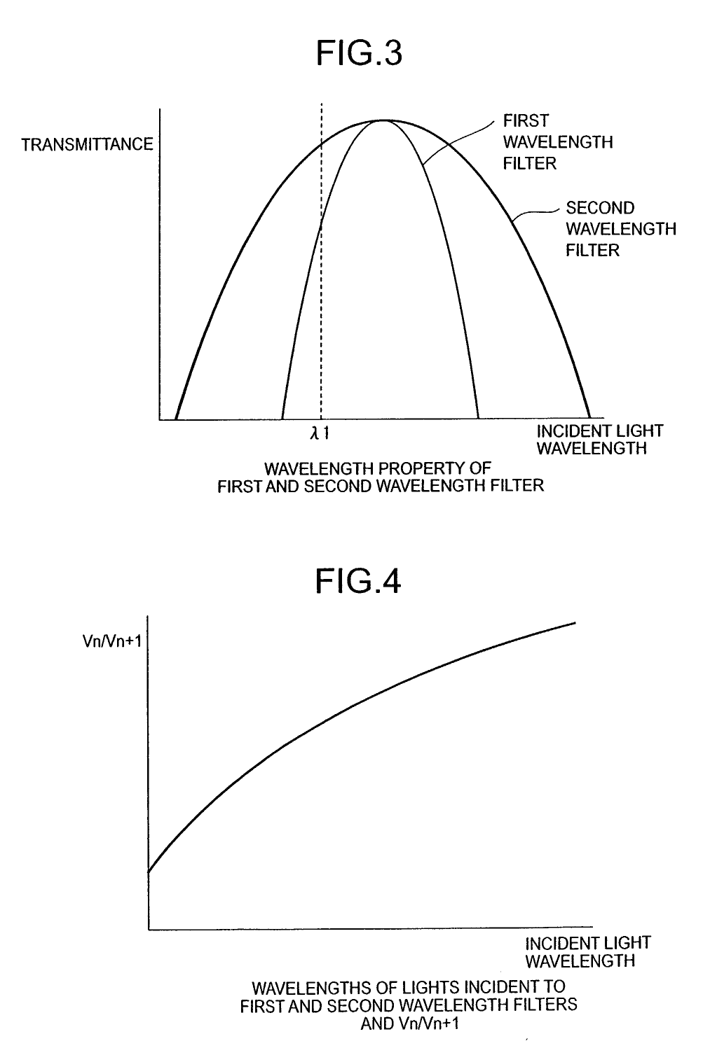

Moreover, in the second embodiment, the forward emitting lights from the respective signal laser modules 102, 103, . . . , are coupled by the optical coupler 105, and amplified by the booster amplifier 106, and then inputted through a single transmission path to the pre-amplifier 118. The light amplified by the pre-amplifier 118 is branched into three directions by an optical distributor 122, and inputted to the optical branching filter 119 and a first wavelength filter and a second wavelength filter 124 having the properties, respectively, as shown in FIG. 3. Incidentally, in the above-mentioned explanation, the light coupled by the optically coupling distributor 107 is the backward emitting light of each signal laser. However, it may be the light obtained by branching the forward emitting light, and the backward emitting light may be used as the power monitor of each signal laser.

The optical branching filter 119 is the variable wavelength filter using, for example, dielectric multiple-layer film, AWG, fiber grating, LNbO3. The input light is branched into a different transmission path for each wavelength, and outputted and received by the first, second, . . . receivers 120, 121, . . . . Both of the first wavelength filter 123 and the second wavelength filter 124 are designed so as to transmit the first signal laser light having the longest wavelength. As for the transmission wavelength range, the range of the first wavelength filter 123 is narrower, as shown in FIG. 3. Incidentally, the transmission wavelength peaks of the two wavelength filters 123, 124 are set on the longer wavelength side than the fluctuation range of the wavelength λ₁ of the first signal laser having the longest wavelength.

The output lights of the two wavelength filters 123, 124 are inputted to the n-th light receiver 125 and the (n+1)-th light receiver 126, respectively. When the output of the n-th light receiver 125 is Vₙ and the output of the (n+1)-th light receiver 126 is Vₙ₊₁, if λ₁ is within the range of the transmission wavelength of the two wavelength filters 123, 124 and shorter than the transmission wavelength peaks of the two wavelength filters 123, 124, Vₙ/Vₙ₊₁ is monotonically increased as the λ₁ is increased, as shown in FIG. 4. A transmission wavelength correction amount calculating circuit 127 stores in advance this property, and uses it to calculate the λ₁ from the value Vₙ/Vₙ₊₁, and further calculates a deviation amount Δλ₁ of the λ₁ from a predetermined wavelength λ₀, and then outputs to an optical branching filter controller 128.

The optical branching filter controller 128 is used to control the transmission wavelength of the optical branching filter 119. For example, if the optical branching filter 119 is the variable wavelength filter using the LiNbO3, it functions as a high frequency voltage generator for generating an elastic surface wave in a LiNbO3 crystal. If the optical branching filter 119 is the fiber grating or the like, it functions as an apparatus for controlling a temperature or a pressure. The optical branching filter controller 128 sets all of the transmission wavelength peaks of the optical branching filter 119, respectively, as follows:

λ₀+Δλ₁,

λ₀+Δλ₁−λₛₜₑₚ,

λ₀+Δλ₁−2λₛₜₑₚ,

. . .

λ₀+Δλ₁−(n−1)λₛₜₑₚ

Here, λₛₜₑₚ is the interval between the wavelengths of the signal lasers, (λ₀+Δλ₁) is the transmission wavelength corresponding to the first signal laser, (λ₀+Δλ₁−λₛₜₑₚ) is the transmission wavelength corresponding to the second signal laser, (λ₀+Δλ₁−2λₛₜₑₚ) is the transmission wavelength corresponding to the third signal laser, and (λ₀+Δλ₁−(n−1)λₛₜₑₚ) is the transmission wavelength corresponding to the n-th signal laser.

In this system, the relative wavelength between the signal lasers is very stabilized by the heterodyne detection. Thus, the respective wavelength change amounts of the signal lasers are substantially equal to each other. Thus, if all of the transmission wavelength peaks of the optical branching filter 119 are changed correspondingly to the change in the wavelength λ₁ of the first signal laser, each signal laser light is normally branched by the optical branching filter 119.

By the way, in the above-mentioned explanation, the wavelength λ₁ of the first signal laser is set to be longer than any of the signal lasers. However, it may be set to be shorter than any of the signal lasers. At this time, the transmission peaks of the first and second wavelength filters 123, 124 are set on the side of the shorter wavelength than the fluctuation range of the wavelength λ₁ of the first signal laser. All of the transmission wavelength peaks of the optical branching filter 119 are set to λ₁+Δλ₁, λ₀+Δλ₁+λₛₜₑₚ, λ₀+Δλ₁+2λₛₜₑₚ, . . . , λ₀+Δλ₁+(n−1) A step, respectively.

<Third Embodiment>

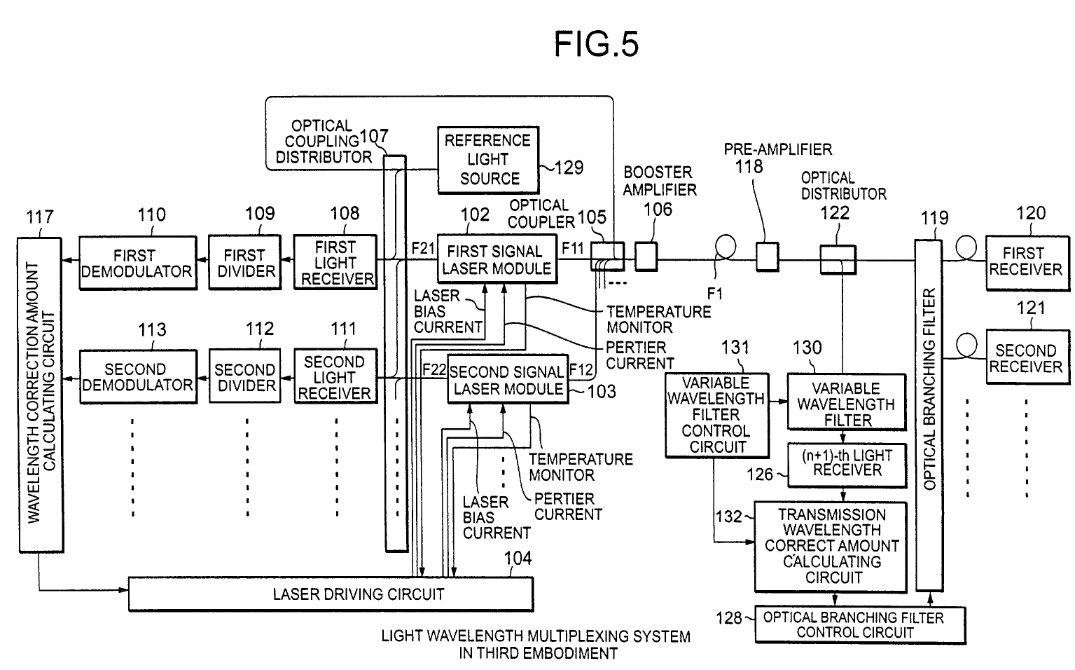

FIG. 5 is a block diagram showing an optical transmitter, an optical receiver and an optical wavelength multiplexing system in a third embodiment. In FIG. 5, a reference light source 129 is a laser light source of non-modulation, and its central wavelength is set to be longer than the wavelengths of any of the signal lasers. N signal laser modules 102, 103, . . . are the semiconductor laser modules in which wavelengths are set to be slightly different from each other, and the modulation is performed on the bias current. They output the laser lights emitted from the front and rear end planes of the laser chip, to the side of the optical fibers (F11, F12, . . . ) and the side of the optical fibers (F21, F22, . . . ), respectively.

Each of the backward emitting lights from the respective signal laser modules 102, 103, . . . and a backward emitting light from the reference light source 129 is coupled with one wave of the wavelength of the adjacent light by the optically coupling distributor 107, and heterodyne-detected by each of the light receivers. The beat signal obtained by the heterodyne detection is processed by the method similar to the first embodiment. On the basis of the thus-obtained correction amount, the target value of the temperature control or the target value of the laser bias current control is corrected.

The forward emitting light from the reference light source 129 and the forward emitting lights from the respective signal laser modules are coupled by the optical coupler 105, and amplified by the booster amplifier 106, and then inputted through a single transmission path to the pre-amplifier 118. The light amplified by the pre-amplifier 118 is branched into two directions by the optical distributor 122, and inputted to the optical branching filter 119 and a variable wavelength filter 130, respectively. The light inputted to the optical branching filter 119 is branched into the different transmission path for each wavelength, and outputted and received by the first, second, . . . receivers 120, 121, . . . Incidentally, in the above-mentioned explanation, the light coupled by the optically coupling distributor 107 is the backward emitting light of the laser. However, it may be the light obtained by branching the forward emitting light, and the backward emitting light may be used as the power monitor of each laser.

The output light of the variable wavelength filter 130 is inputted to the (n+1)-th light receiver 126. An optical intensity detected thereby is inputted to a transmission wavelength correction amount calculating circuit 132. A variable wavelength filter controller 131 usually sets a transmission wavelength peak λ_{f} of the variable wavelength filter 130 to λ₀ on a longer wavelength side than a fluctuation range of a central wavelength λᵣ of the reference laser, and periodically sweeps it in a short wavelength direction with the λ₀ as an origin, and also outputs the signal, which indicates a present transmission wavelength setting value of the variable wavelength filter 130 and also indicates that it is presently being swept, to the transmission wavelength correction amount calculating circuit 132.

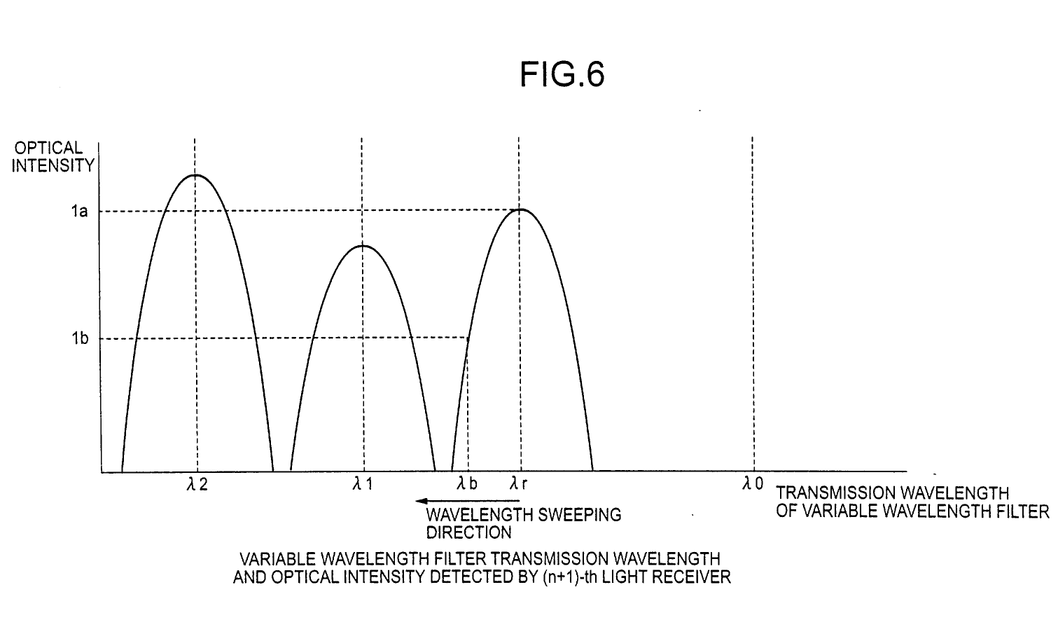

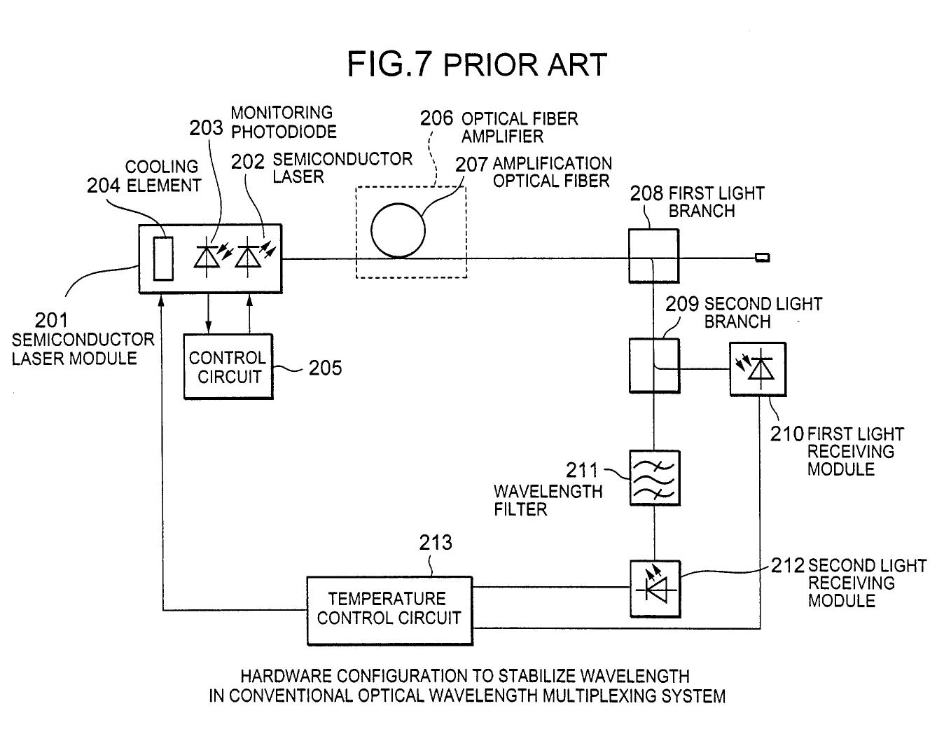

While it is swept, the transmission optical intensity of the variable wavelength filter 130 detected by the (n+1)-th light receiver 126 is as shown in FIG. 6. In FIG. 6, λᵣ is the central wavelength of the reference laser, λ₁ is the central wavelength of the first signal laser, and λ₂ is the central wavelength of the second signal laser. However, since the signal lasers are modulated, there may be a case that the optical intensities in the vicinities of the λ₁ and the λ₂ are actually different from those shown in FIG. 6.

The transmission wavelength correction amount calculating circuit 132 calculates the wavelength λᵣ of the reference laser, from the output of the (n+1)-th light receiver 126 and the output of the variable wavelength filter controller 131. The calculating method will be described below.

While the variable wavelength filter controller 131 sends the signal indicating that the transmission wavelength is being swept, the transmission wavelength correction amount calculating circuit 132 records an optical intensity I detected by the (n+1)-th light receiver 126. While it is swept or after it is swept, the transmission wavelength correction amount calculating circuit 132 calculates the maximum value Iₐ of the optical intensities I firstly observed after the start of the sweeping operation. In succession, the transmission wavelength correction amount calculating circuit 132 calculates a transmission wavelength setting value λ_{b} when the I is reduced by a predetermined rate, with respect to the maximum value Iₐ. Since the λ_{b} is made shorter by a certain wavelength Δλ than the wavelength λᵣ of the reference laser, the transmission wavelength correction amount calculating circuit 132 calculates λᵣ from the following equation:

λᵣ=λ_{b}+Δλ

By the way, the Δλ is a constant determined from the wavelength property of the variable wavelength filter 130, a line width of the reference laser and a property of the booster amplifier 106, and it is stored in advance in the transmission wavelength correction amount calculating circuit 132. The thus-obtained λᵣ is outputted to the optical branching filter controller 128.

The optical branching filter controller 128 sets the respective transmission wavelength peaks of the optical branching filter 119 to λᵣ−λₛₜₑₚ, λᵣ−2λₛₜₑₚ, . . . , λᵣ−n λₛₜₑₚ, respectively. Here, the λₛₜₑₚ is the interval between the wavelengths of the signal lasers, the (λᵣ−λₛₜₑₚ) is the transmission wavelength corresponding to the first signal laser, the (λᵣ−2λₛₜₑₚ) is the transmission wavelength corresponding to the second signal laser, and the (λᵣ−nλₛₜₑₚ) is the transmission wavelength corresponding to the n-th signal laser. In this system, the relative wavelength between the lasers is very stabilized by the heterodyne detection. Thus, the wavelength change amounts of the respective lasers are substantially equal to each other. Thus, if all of the transmission wavelength peaks of the optical branching filter 119 are changed correspondingly to the change in the λᵣ, each signal laser light is normally branched by the optical branching filter 119.

By the way, in the above-mentioned explanation, the wavelength of the reference light source 129 is set to be longer than any of the signal lasers. However, it may be set to be shorter than any of the signal lasers. At this time, the variable wavelength filter controller 131 usually sets the transmission wavelength peak λ_{f} of the variable wavelength filter 130 to λ₀ on the side of a shorter wavelength than the fluctuation range of the central wavelength λᵣ of the reference laser, and periodically sweeps it in a long wavelength direction with the λ₀ as an origin. The λᵣ is determined from λᵣ=λ_{b}−Δλ. The respective transmission wavelength peaks of the optical branching filter 119 are set to λᵣ+λₛₜₑₚ, λᵣ+2λₛₜₑₚ, . . . , λᵣ+nλₛₜₑₚ, respectively.

As mentioned above, according to the present invention, it is possible to send and receive the multiplexed wavelength signal which is extremely stable, only by adjusting the relative wavelength through the heterodyne detection, without any absolute wavelength control using the expensive optical elements such as the wavelength filter, the optical resonator and the like.

Also, the resolution in the wavelength interval measurement using the heterodyne detection is very high, which enables the fluctuation to be measured until the order of several MHz. Thus, the wavelength interval can be precisely adjusted over the case when the absolute wavelength control is performed on each of the signal lasers. Hence, it is possible to minimize the interference with the lights of the other wavelengths on the transmission path.

What is claimed is:

1. An optical transmitter, comprising:
a plurality of signal light sources for respectively emitting lights each having different wavelength from one another;
a unit for obtaining a beat signal through photo-electric conversion by coupling an emitting light from one of said signal light sources with one adjacent wave of a different wavelength; and
a unit for controlling the wavelength of said signal light source so that a frequency of said beat signal is constant.

2. The optical transmitter according to claim 1, wherein the wavelength is controlled by changing a temperature of said signal light source.

3. The optical transmitter according to claim 1, wherein the wavelength is controlled by changing an injection current of said signal light source.

4. The optical transmitter according to claim 1, wherein the wavelength is controlled by changing a temperature of said signal light source, and
that optical intensity is stabilized and controlled by changing an injection current.

5. The optical transmitter according to claim 1, wherein a light used to control the wavelength of said signal light source is a backward emitting light of a semiconductor laser.

6. The optical transmitter according to claim 1, wherein a light used to control the wavelength of said signal light source is a light obtained by branching a forward emitting light of a semiconductor laser.

7. The optical transmitter according to claim 1, wherein wavelength controls with regard to said signal light source are all carried out at different speeds.

8. An optical transmitter, comprising:
a plurality of signal light sources for respectively emitting lights each having different wavelength from one another;
a reference light source;
a unit for obtaining a beat signal by coupling emitting lights from said reference light source and said signal light source with one wave of an adjacent wavelength and carrying out a photo-electric conversion; and
a unit for controlling the wavelength of said signal light source so that a frequency of said beat signal is constant.

9. The optical transmitter according to claim 8, wherein said reference light source has a wavelength stableness higher than those of said plurality of signal light sources.

10. The optical transmitter according to claim 8, wherein a wavelength of said reference light source is longer than all wavelengths of said signal light sources.

11. The optical transmitter according to claim 8, wherein a wavelength of said reference light source is shorter than all wavelengths of said signal light sources.

12. The optical transmitter according to claim 8, wherein the wavelength is controlled by changing a temperature of said signal light source.

13. The optical transmitter according to claim 8, wherein the wavelength is controlled by changing an injection current of said signal light source.

14. The optical transmitter according to claim 8, wherein the wavelength is controlled by changing a temperature of said signal light source, and
that optical intensity is stabilized and controlled by changing an injection current.

15. The optical transmitter according to claim 8, wherein a light used to control the wavelength of said signal light source is a backward emitting light of a semiconductor laser.

16. The optical transmitter according to claim 8, wherein a light used to control the wavelength of said signal light source is a light obtained by branching a forward emitting light of a semiconductor laser.

17. The optical transmitter according to claim 8, wherein wavelength controls with regard to said signal light source are all carried out at different speeds.

18. An optical receiver, comprising:
a unit for branching a light into three directions to be inputted to an optical branching filter as well as a first wavelength filter and a second wavelength filter having different transmission property from each other;
a unit for detecting intensities of emitting lights from said first wavelength filter and said second wavelength filter; and
a unit for calculating a ratio between the intensity of the emitting light from said first wavelength filter and the intensity of the emitting light from said second wavelength filter, and calculating a deviation amount of this ratio from a predetermined reference value, and then shifting peaks of all transmission wavelengths through said optical branching filter by an equal amount, in accordance with said deviation amount.

19. The optical receiver according to claim 18,
wherein a transmission wavelength range of said second wavelength filter is wider than that of said first wavelength filter.

20. The optical receiver according to claim 18,
wherein said first wavelength filter and said second wavelength filter have characteristics so as to transmit a light having the longest wavelength among received lights, and
transmission peaks of said first wavelength filter and said second wavelength filter are set on a longer wavelength side than a wavelength fluctuation range of the light having the longest wavelength among the received light.

21. The optical receiver according to claim 18,
wherein said first wavelength filter and said second wavelength filter have characteristics so as to transmit a light having the shortest wavelength among received lights, and
transmission peaks of said first wavelength filter and said second wavelength filter are set on a shorter wavelength side than a wavelength fluctuation range of the light having the shortest wavelength among the received light.

22. An optical receiver, comprising:
a unit for branching a light into two directions, and sending to an optical branching filter and a variable wavelength filter, respectively;
a unit for detecting a transmitted light intensity of said variable wavelength filter;
a unit for sweeping a transmission wavelength of said variable wavelength filter with a predetermined wavelength as an origin, and after the transmitted light intensity of said variable wavelength filter passes a first peak, detecting a transmission wavelength when it becomes firstly smaller by a certain rate than said peak; and
a unit for shifting the peaks of all of the transmission wavelengths of said optical branching filter by an equal amount in accordance with said detected transmission wavelength.

23. The optical receiver according to claim 22,
wherein the origin from which the transmission wavelength of said variable wavelength filter is swept is located on a longer wavelength side than a wavelength fluctuation range of the reference light source included in received lights, and
a sweeping direction is a direction to a shorter wavelength side from a longer wavelength side.

24. The optical receiver according to claim 22,
wherein the origin from which the transmission wavelength of said variable wavelength filter is swept is located on a shorter wavelength side than a wavelength fluctuation range of the reference light source included in received lights, and
a sweeping direction is a direction to a longer wavelength side from a shorter wavelength side.

25. An optical wavelength multiplexing system, at least comprising:
an optical transmitter including:
a plurality of signal light sources for respectively emitting lights each having different wavelength from one another;
a unit for obtaining a beat signal by coupling an emitting light from said signal light source with one wave of an adjacent wavelength and carrying out a photo-electric conversion; and
a unit for controlling the wavelength of said signal light source so that a frequency of said beat signal is constant; and
an optical receiver including:
a unit for branching a light into three directions and sending to an optical branching filter and a first wavelength filter and a second wavelength filter which are different in transmission property;
a unit for detecting transmitted light intensities of said first wavelength filter and said second wavelength filter; and
a unit for calculating a ratio between the transmitted light intensity of said first wavelength filter and the transmitted light intensity of said second wavelength filter, and calculating a deviation amount of this ratio from a predetermined standard value, and then shifting peaks of all transmission wavelengths of said optical branching filter by an equal amount, in accordance with said deviation amount.

26. An optical wavelength multiplexing system, at least comprising:
an optical transmitter including:
a plurality of signal light sources for respectively emitting lights each having different wavelength from one another;
a unit for obtaining a beat signal by coupling an emitting light from said signal light source with one wave of an adjacent wavelength and carrying out a photo-electric conversion; and
a unit for controlling the wavelength of said signal light source so that a frequency of said beat signal is constant; and
an optical receiver including:
a unit for branching a light into two directions, and sending to an optical branching filter and a variable wavelength filter, respectively;
a unit for detecting a transmitted light intensity of said variable wavelength filter;
a unit for sweeping a transmission wavelength of said variable wavelength filter with a predetermined wavelength as an origin, and after the transmitted light intensity of said variable wavelength filter passes a first peak, detecting a transmission wavelength when it becomes firstly smaller by a certain rate than said peak; and
a unit for shifting the peaks of all of the transmission wavelengths of said optical branching filter by an equal amount in accordance with said detected transmission wavelength.

27. An optical wavelength multiplexing system, at least comprising:
an optical transmitter including:
a plurality of signal light sources for respectively emitting lights each having different wavelength from one another;
a reference light source;
a unit for obtaining a beat signal by coupling emitting lights from said reference light source and said signal light source with one wave of an adjacent wavelength and carrying out a photo-electric conversion; and
a unit for controlling the wavelength of said signal light source so that a frequency of said beat signal is constant; and
an optical receiver including:
a unit for branching a light into three directions and sending to an optical branching filter and a first wavelength filter and a second wavelength filter which are different in transmission property;
a unit for detecting transmitted light intensities of said first wavelength filter and said second wavelength filter; and
a unit for calculating a ratio between the transmitted light intensity of said first wavelength filter and the transmitted light intensity of said second wavelength filter, and calculating a deviation amount of this ratio from a predetermined standard value, and then shifting peaks of all transmission wavelengths of said optical branching filter by an equal amount, in accordance with said deviation amount.

28. An optical wavelength multiplexing system, at least comprising:
an optical transmitter including:
a plurality of signal light sources for respectively emitting lights each having different wavelength from one another;
a reference light source;
a unit for obtaining a beat signal by coupling emitting lights from said reference light source and said signal light source with one wave of an adjacent wavelength and carrying out a photo-electric conversion; and
a unit for controlling the wavelength of said signal light source so that a frequency of said beat signal is constant; and
an optical receiver including:
a unit for branching a light into two directions, and sending to an optical branching filter and a variable wavelength filter, respectively;
a unit for detecting a transmitted light intensity of said variable wavelength filter;
a unit for sweeping a transmission wavelength of said variable wavelength filter with a predetermined wavelength as an origin, and after the transmitted light intensity of said variable wavelength filter passes a first peak, detecting a transmission wavelength when it becomes firstly smaller by a certain rate than said peak; and
a unit for shifting the peaks of all of the transmission wavelengths of said optical branching filter by an equal amount in accordance with said detected transmission wavelength.
